(19) United States
(12) Patent Application Publication
(10) Pub. No.: US 2020/0099257 A1
(43) Pub. Date: Mar. 26, 2020

(54) Wireless Power System With Dynamic Battery Charging

(71) Applicant: Apple Inc., Cupertino, CA (US)

(72) Inventors: Weihong Qiu, San Ramon, CA (US); Jun Liu, San Jose, CA (US); Zaki Moussaoui, San Carlos, CA (US); Karl Ruben F. Larsson, Los Altos, CA (US)

(21) Appl. No.: 16/576,692

(22) Filed: Sep. 19, 2019

Related U.S. Application Data
(60) Provisional application No. 62/734,579, filed on Sep. 21, 2018.

(51) Int. Cl. H02J 50/12; H01M 10/46; H02J 7/02; H04B 5/00; H02J 50/80

(52) U.S. Cl. CPC H02J 50/12; H01M 10/46; H02J 50/80; H04B 5/0037; H02J 7/025

(57) ABSTRACT

A wireless power system may have a wireless power transmitting device and a wireless power receiving device. The wireless power receiving device may have a coil that receives wireless power signals from the wireless power transmitting device and may have a rectifier that produces direct-current power from the received wireless power signals. A charging status indicator may be displayed by the wireless power receiving device during wireless power transmission. Control circuitry in the wireless power receiving device may monitor the output voltage to determine whether wireless power transmission has been lost. The charging status indicator may continue to be displayed for a debounce period following detection of loss of wireless power transmission. The debounce period may be adjusted based on whether power loss is due to user movement of the receiving device or termination of power transmission by the transmitting device.

This application claims the benefit of provisional patent application No. 62/734,579, filed Sep. 21, 2018, which is hereby incorporated by reference herein in its entirety.

### FIELD

This relates generally to wireless systems, and, more particularly, to systems in which devices are wirelessly charged.

### BACKGROUND

In a wireless charging system, a wireless power transmitting device such as a device with a charging surface wirelessly transmits power to a portable electronic device. The portable electronic device receives the wirelessly transmitted power and uses this power to charge an internal battery and power components. It can be challenging to regulate the flow of wireless power in a wireless charging system. If care is not taken, wireless power transfer efficiency may be sub-optimal and power delivery requirements may not be satisfied.

### SUMMARY

A wireless power system has a wireless power transmitting device and a wireless power receiving device. The wireless power transmitting device may be a wireless charging mat with a charging surface. The wireless power transmitting device transmits wireless power signals by driving one or more transmit coils at a selected duty cycle using inverter circuitry. The wireless power receiving device has a coil that receives the wireless power signals from the wireless power transmitting device when the wireless power receiving device is resting on the charging surface. The wireless power receiving device has a rectifier that produces direct-current power from the received wireless power signals.

The wireless power receiving device has a battery and battery charger circuitry. The battery charger circuitry receives a rectifier output voltage from the rectifier. The battery charger circuitry converts the rectifier output voltage into a charging voltage. The battery charger circuitry charges the battery using the charging voltage. The battery charger circuitry includes at least one switched capacitor circuit that divides the rectifier output voltage by a given factor. The battery charger circuitry may include additional stages of switched capacitor converters and/or a buck converter. The battery charger circuitry may use the output of any of the switched capacitor converters or the buck converter as the charging voltage for charging the battery. The battery charger circuitry may include bypass switches to selectively bypass (deactivate) some or all of the converters.

The control circuitry is coupled to wireless transceiver circuitry such as a feedback transmitter. The feedback transmitter includes a modulator and a driver and is coupled to one or more capacitor electrodes. The control circuitry gathers signal measurements such as voltage and current measurements associated with charging the battery. The control circuitry generates feedback signals based on the signal measurements. The modulator modulates the feedback signals and the driver drives the modulated feedback signals onto the capacitor electrodes to wirelessly transmit the feedback signals to capacitor electrodes on the wireless power transmitting device. The wireless power transmitting device includes a feedback receiver that receives the feedback signals over the capacitor electrodes on the wireless power transmitting device. Control circuitry on the wireless power transmitting device adjusts the duty cycle of the inverter circuitry based on the received feedback signals.

### BRIEF DESCRIPTION OF THE DRAWINGS

FIG. 1 is a schematic diagram of an illustrative wireless charging system that includes a wireless power transmitting device and a wireless power receiving device in accordance with an embodiment.

FIG. 2 is a top view of an illustrative wireless power transmitting device with an array of coils that forms a wireless charging surface in accordance with an embodiment.

FIG. 3 is a circuit diagram of an illustrative wireless charging system in accordance with an embodiment.

FIG. 4 is a diagram of illustrative battery charger circuitry that includes a switched capacitor converter in accordance with an embodiment.

FIG. 5 is a diagram of illustrative battery charger circuitry that includes multiple switched capacitor converters in accordance with an embodiment.

FIG. 6 is a circuit diagram of illustrative battery charger circuitry that includes multiple switched capacitor converters in accordance with an embodiment.

FIG. 7 is a graph of voltage as a function of time showing how an illustrative switched capacitor converter divides an input voltage in accordance with an embodiment.

FIG. 8 is an illustrative graph of battery charger efficiency as a function of current for different types of power converters in accordance with an embodiment.

FIG. 9 is a diagram of illustrative battery charger circuitry that includes switched capacitor converters and bypass switches in accordance with an embodiment.

FIG. 10 is a diagram of illustrative battery charger circuitry that includes a switched capacitor converter and a buck converter in accordance with an embodiment.

FIG. 11 is a diagram of illustrative battery charger circuitry that includes a first switched capacitor converter and switching circuitry for selectively activating a buck converter or a second switched capacitor converter in accordance with an embodiment.

FIG. 12 is a diagram of illustrative battery charger circuitry that includes switching circuitry for selectively activating a buck converter or a switched capacitor converter in accordance with an embodiment.

FIG. 13 is a circuit diagram of an illustrative buck converter in accordance with an embodiment.

FIG. 14 is a flow chart of illustrative operations that may be performed by a wireless charging system in accordance with an embodiment.

FIG. 15 is a top-down view of an illustrative capacitor electrode that is used to perform wireless data transfer in a wireless power system in accordance with an embodiment.

FIG. 16 is a top-down view of illustrative concentric capacitor electrodes that are used to perform wireless data transfer in a wireless power system in accordance with an embodiment.

### DETAILED DESCRIPTION

A wireless power system has a wireless power transmitting device that transmits power wirelessly to a wireless power receiving device. The wireless power transmitting device is a device such as a wireless charging mat, wireless charging puck, wireless charging stand, wireless charging table, or other wireless power transmitting equipment. The wireless power transmitting device has one or more coils that are used in transmitting wireless power to one or more wireless power receiving coils in the wireless power receiving device. The wireless power receiving device is a device such as a cellular telephone, watch, media player, tablet computer, pair of earbuds, remote control, laptop computer, other portable electronic device, or other wireless power receiving equipment. One of these types of devices can also be used to form the wireless power transmitting device if desired.

During operation, the wireless power transmitting device supplies alternating-current drive signals to one or more wireless power transmitting coils. This causes the coils to transmit alternating-current electromagnetic signals (sometimes referred to as wireless power signals) to one or more corresponding coils in the wireless power receiving device. Rectifier circuitry in the wireless power receiving device converts received wireless power signals into direct-current (DC) power for powering the wireless power receiving device.

The wireless power system uses a control scheme that helps enhance wireless power transfer efficiency while satisfying power demands from the wireless power receiving device. During operation, the wireless power receiving device makes changes to the current drawn by a battery charger circuit in the wireless power receiving device and makes duty cycle adjustments to the wireless power transmitting device drive signals and wireless power signals while monitoring power, current, and/or voltage from the rectifier circuitry, battery charger circuit, and/or battery using sensor circuitry.

The battery charger circuit includes at least one switched capacitor converter that supplies the battery with a desired charging voltage. The switched capacitor converter exhibits greater charging efficiency than other types of voltage converters that include inductors such as buck converters. The wireless power receiving device and the wireless power transmitting device each include capacitor electrodes. The wireless power receiving device makes duty cycle adjustments to the wireless power transmitting device over a capacitive link between the capacitor electrodes. Performing duty cycle adjustments over the capacitive link is faster and is less susceptible to electromagnetic noise than adjusting duty cycle over an in-band communications link between the wireless power transmitting and receiving coils.

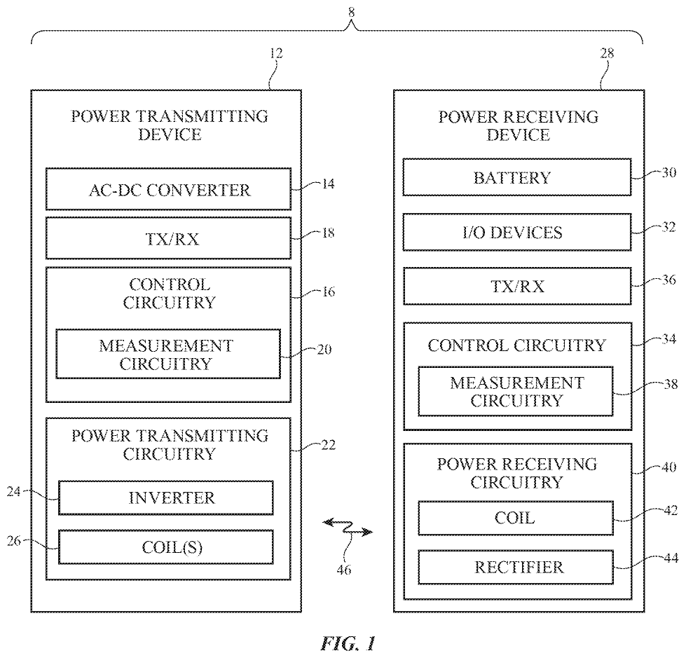

An illustrative wireless power system (wireless charging system) is shown in FIG. 1. As shown in FIG. 1, wireless power system 8 includes wireless power transmitting device 12 and one or more wireless power receiving devices such as wireless power receiving device 28. Wireless power transmitting device 12 includes control circuitry 16. Wireless power receiving device 28 includes control circuitry 34. Control circuitry in system 8 such as control circuitry 16 and control circuitry 34 is used in controlling the operation of system 8. This control circuitry may include processing circuitry associated with microprocessors, power management units, baseband processors, digital signal processors, microcontrollers, and/or application-specific integrated circuits with processing circuits. The processing circuitry implements desired control and communications features in devices 12 and 28. For example, the processing circuitry may be used in selecting coils, determining power transmission levels, processing sensor data and other data, processing user input, handling negotiations between devices 12 and 28, sending and receiving in-band and out-of-band data, making measurements, and otherwise controlling the operation of system 8.

Control circuitry in system 8 may be configured to perform operations in system 8 using hardware (e.g., dedicated hardware or circuitry), firmware, and/or software. Software code for performing operations in system 8 is stored on non-transitory computer readable storage media (e.g., tangible computer readable storage media) in control circuitry 16 and/or 34. The software code may sometimes be referred to as program instructions, software, data, instructions, or code. The non-transitory computer readable storage media may include non-volatile memory such as non-volatile random-access memory (NVRAM), one or more hard drives (e.g., magnetic drives or solid state drives), one or more removable flash drives or other removable media, etc. Software stored on the non-transitory computer readable storage media may be executed on the processing circuitry of control circuitry 16 and/or 34. The processing circuitry may include application-specific integrated circuits with processing circuitry, one or more microprocessors, a central processing unit (CPU) or other processing circuitry.

Power transmitting device 12 may be a stand-alone power adapter (e.g., a wireless charging mat that includes power adapter circuitry), may be a wireless charging mat that is coupled to a power adapter or other equipment by a cable, may be a portable device (e.g., a laptop computer, desktop computer, tablet computer, cellular telephone, etc.), may be equipment that has been incorporated into furniture, a vehicle, or other system, or may be other wireless power transfer equipment. Illustrative configurations in which wireless power transmitting device 12 is a wireless charging mat are sometimes described herein as an example.

Power receiving device 28 may be a portable electronic device such as a wristwatch, a cellular telephone, a laptop computer, a tablet computer, an accessory such as an earbud, or other electronic equipment. Power transmitting device 12 may be coupled to a wall outlet (e.g., an alternating current power source), may have a battery for supplying power, and/or may have another source of power. Power transmitting device 12 may have an alternating-current (AC) to direct-current (DC) power converter such as AC-DC power converter 14 for converting AC power from a wall outlet or other power source into DC power. DC power may be used to power control circuitry 16. During operation, a controller in control circuitry 16 uses power transmitting circuitry 22 to transmit wireless power to power receiving circuitry 40 of device 28. Power transmitting circuitry 22 may have switching circuitry (e.g., inverter circuitry 24 formed from transistors) that is turned on and off based on control signals provided by control circuitry 16 to create AC current signals through one or more wireless power transmitting coils such as transmit coils 26. Coils 26 may be arranged in a planar coil array (e.g., in configurations in which device 12 is a wireless charging mat).

As the AC currents pass through one or more coils 26, alternating-current electromagnetic (e.g., magnetic) fields (signals 46) are produced that are received by one or more corresponding receiver coils such as coil 42 in power receiving device 28. When the alternating-current electromagnetic fields are received by coil 42, corresponding alternating-current currents are induced in coil 42. Rectifier circuitry such as rectifier 44, which contains rectifying components such as synchronous rectification metal-oxide-semiconductor transistors arranged in a bridge network, converts received AC signals (received alternating-current signals associated with electromagnetic signals 46) from coil 42 into DC voltage signals for powering device 28.

The DC voltages produced by rectifier 44 (sometime referred to as rectifier output voltage V_{RECT}) can be used in charging a battery such as battery 30 and can be used in powering other components in device 28. For example, device 28 may include input-output (I/O) devices 32 such as a display, touch sensor, communications circuits, audio components, sensors, light-emitting diode status indicators, other light-emitting and light detecting components, and other components and these components may be powered by the DC voltages produced by rectifier 44 (and/or DC voltages produced by battery 30).

Device 12 and/or device 28 communicate wirelessly using in-band and/or out-of-band communications. Device 12 includes wireless transceiver circuitry 18. The wireless transceiver circuitry may include wireless transmitter circuitry that wirelessly transmits out-of-band signals to device 28 over a far field link (e.g., using an antenna) and/or over a near field link (e.g., using one or more capacitor electrode or dedicated inductive coil(s) separate from power transmitting coils 26). Wireless transceiver circuitry 18 includes wireless receiver circuitry that wirelessly receives out-of-band signals from device 28 using the capacitor electrodes, dedicated inductive coils, and/or antenna. Device 28 includes wireless transceiver circuitry 36. Wireless transceiver circuitry 36 includes wireless transmitter circuitry that transmits out-of-band signals to device 12 using one or more capacitor electrodes, one or more dedicated inductive coils separate from coil 42, and/or an antenna. Wireless transceiver circuitry 36 may include wireless receiver circuitry that uses the capacitor electrodes, dedicated inductive coils, and/or antenna to receive out-of-band signals from device 12.

Wireless transceiver circuitry 18 can use one or more wireless power transmitting coils 26 to transmit in-band signals to wireless transceiver circuitry 36 that are received by wireless transceiver circuitry 36 using wireless power receiving coil 42. Any suitable modulation scheme may be used to support in-band communications between device 12 and device 28. With one illustrative configuration, frequency-shift keying (FSK) is used to convey in-band data from device 12 to device 28 and amplitude-shift keying (ASK) is used to convey in-band data from device 28 to device 12. Power may be conveyed wirelessly from device 12 to device 28 during these FSK and ASK transmissions. Other types of in-band communications may be used, if desired.

During wireless power transmission operations, circuitry 22 supplies AC drive signals to one or more coils 26 at a given power transmission frequency. The power transmission frequency may be, for example, a predetermined frequency of about 125 kHz, at least 80 kHz, at least 100 kHz, less than 500 kHz, less than 300 kHz, or other suitable wireless power frequency. In some configurations, the power transmission frequency may be negotiated in communications between devices 12 and 28. In other configurations, the power transmission frequency may be fixed.

During wireless power transfer operations, while power transmitting circuitry 22 is driving AC signals into one or more of coils 26 to produce signals 46 at the power transmission frequency, wireless transceiver circuitry 18 uses FSK modulation to modulate the power transmission frequency of the driving AC signals and thereby modulate the frequency of signals 46. In device 28, coil 42 is used to receive signals 46. Power receiving circuitry 40 uses the received signals on coil 42 and rectifier 44 to produce DC power. At the same time, wireless transceiver circuitry 36 uses FSK demodulation to extract the transmitted in-band data from signals 46. This approach allows FSK data (e.g., FSK data packets) to be transmitted in-band from device 12 to device 28 with coils 26 and 42 while power is simultaneously being wirelessly conveyed from device 12 to device 28 using coils 26 and 42.

In-band communications from device 28 to device 12 uses ASK modulation and demodulation techniques. Wireless transceiver circuitry 36 transmits in-band data to device 12 by using a switch (e.g., one or more transistors in transceiver 36 that are coupled coil 42) to modulate the impedance of power receiving circuitry 40 (e.g., coil 42). This, in turn, modulates the amplitude of signal 46 and the amplitude of the AC signal passing through coil(s) 26. Wireless transceiver circuitry 18 monitors the amplitude of the AC signal passing through coil(s) 26 and, using ASK demodulation, extracts the transmitted in-band data from these signals that was transmitted by wireless transceiver circuitry 36. The use of ASK communications allows ASK data bits (e.g., ASK data packets) to be transmitted in-band from device 28 to device 12 with coils 42 and 26 while power is simultaneously being wirelessly conveyed from device 12 to device 28 using coils 26 and 42.

Control circuitry 16 has external object measurement circuitry 20 (sometimes referred to as foreign object detection circuitry or external object detection circuitry) that detects external objects on a charging surface associated with device 12. Circuitry 20 can detect foreign objects such as coils, paper clips, and other metallic objects and can detect the presence of wireless power receiving devices 28. During object detection and characterization operations, external object measurement circuitry 20 can be used to make measurements on coils 26 to determine whether any devices 28 are present on device 12.

In an illustrative arrangement, measurement circuitry 20 of control circuitry 16 contains signal generator circuitry (e.g., oscillator circuitry for generating AC probe signals at one or more probe frequencies, a pulse generator, etc.) and signal detection circuitry (e.g., filters, analog-to-digital converters, impulse response measurement circuits, etc.). During measurement operations, switching circuitry in device 12 may be adjusted by control circuitry 16 to switch each of coils 26 into use. As each coil 26 is selectively switched into use, control circuitry 16 uses the signal generator circuitry of signal measurement circuitry 20 to apply a probe signal to that coil while using the signal detection circuitry of signal measurement circuitry 20 to measure a corresponding response. Measurement circuitry 38 in control circuitry 34 and/or measurement circuitry 20 in control circuitry 16 may also be used in making current and voltage measurements.

The characteristics of each coil 26 depend on whether any foreign objects overlap that coil (e.g., coins, wireless power receiving devices, etc.) and also depend on whether a wireless power receiving device with a coil such as coil 42 of FIG. 1 is present, which could increase the measured inductance of any overlapped coil 26. Signal measurement circuitry 20 is configured to apply signals to the coil and measure corresponding signal responses. For example, signal measurement circuitry 20 may apply an alternating-current probe signal while monitoring a resulting signal at a node coupled to the coil. As another example, signal measurement circuitry 20 may apply a pulse to the coil and measure a resulting impulse response (e.g., to measure coil inductance). Using measurements from measurement circuitry 20, the wireless power transmitting device can determine whether an external object is present on the coils. If, for example, all of coils 26 exhibit their expected nominal response to the applied signals, control circuitry 16 can conclude that no external devices are present. If one of coils 26 exhibits a different response (e.g., a response varying from a normal no-objects-present baseline), control circuitry 16 can conclude that an external object (potentially a compatible wireless power receiving device) is present.

Control circuitry 34 has measurement circuitry 38. In an illustrative arrangement, measurement circuitry 38 of control circuitry 34 contains signal generator circuitry (e.g., oscillator circuitry for generating AC probe signals at one or more probe frequencies, a pulse generator, etc.) and signal detection circuitry (e.g., filters, analog-to-digital converters, impulse response measurement circuits, etc.). During measurement operations, device 28 may use measurement circuitry 38 to make measurements to characterize device 28 and the components of device 28. For example, device 28 may use measurement circuitry 38 to measure the inductance of coil 42 (e.g., signal measurement circuitry 38 may be configured to measure signals at coil 42 while supplying coil 42 with signals at one or more frequencies (to measure coil inductances), signal pulses (e.g., so that impulse response measurement circuitry in the measurement circuitry can be used to make inductance and Q factor measurements), etc. Measurement circuitry 38 may also make measurements of the output voltage of rectifier 44, the output current of rectifier 44, voltage across battery 30, current at battery 30, voltage in battery charger circuitry for battery 30, current in battery charger circuitry for battery 30, etc.

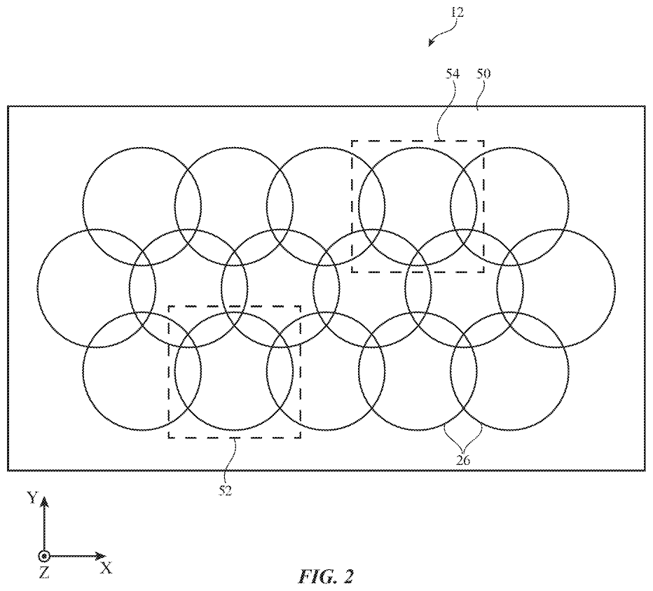

A top view of an illustrative configuration for device 12 in which device 12 has an array of coils 26 is shown in FIG. 2. Device 12 may, in general, have any suitable number of coils 26 (e.g., 16 coils, at least 5 coils, at least 10 coils, at least 15 coils, at least four coils, one coil, two coils, three coils, fewer than 30 coils, at least 30 coils, fewer than 50 coils, etc.). In the example of FIG. 2, device 12 has an array of coils 26 that lie in the X-Y plane. Coils 26 of device 12 are covered by a planar dielectric structure such as a plastic member or other structure forming charging surface 50. The lateral dimensions (X and Y dimensions) of the array of coils 26 in device 36 may be 1-1000 cm, 5-50 cm, more than 5 cm, more than 20 cm, less than 200 cm, less than 75 cm, or other suitable size. Coils 26 may overlap or may be arranged in a non-overlapping configuration. Coils 26 can be placed in a rectangular array having rows and columns and/or may be tiled using a hexagonal tile pattern or other pattern.

During operation, a user places one or more devices 28 on charging surface 50 (see, e.g., illustrative external objects 52 and 54). Foreign objects such as coils, paper clips, scraps of metal foil, and/or other foreign conductive objects may be accidentally placed on surface 50. System 8 automatically detects whether conductive objects located on surface 50 correspond to wireless power receiving devices such as device 28 of FIG. 1 or incompatible foreign objects and takes suitable action (e.g., by transmitting wireless power to devices 28 and blocking power transmission to incompatible foreign objects).

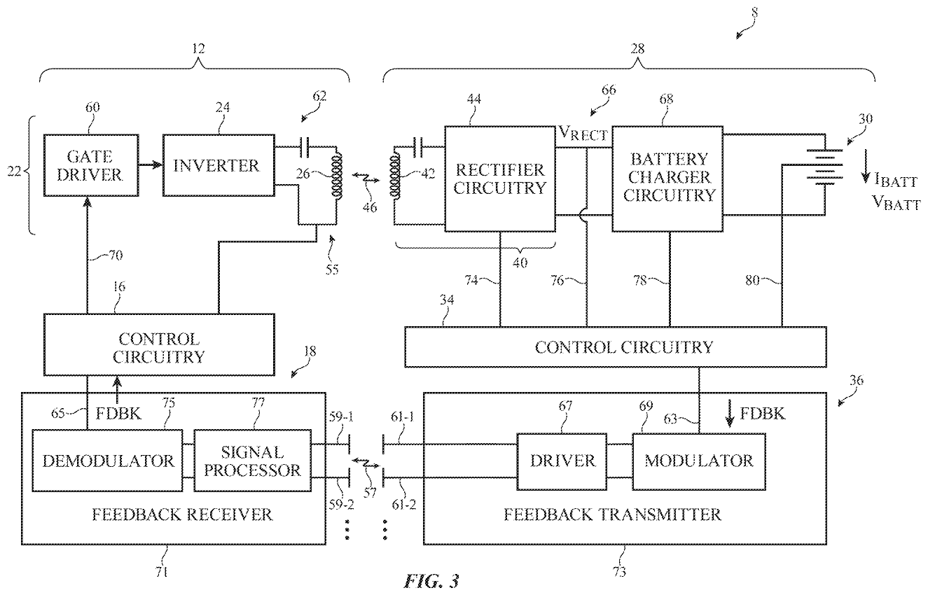

A circuit diagram of illustrative circuitry for wireless power transfer (wireless power charging) system 8 is shown in FIG. 3. As shown in FIG. 3, wireless power transmitting circuitry 22 includes an inverter such as inverter 24 or other drive circuit that produces alternating-current drive signals such as variable duty-cycle square waves. These signals are driven through an output circuit 55 that includes coil(s) 26 and capacitor(s) 62 to produce wireless power signals with the same variable duty cycle that are transmitted wirelessly to device 28.

A single coil 26 is shown in the example of FIG. 3. In general, device 12 may have any suitable number of coils (1-100, more than 5, more than 10, fewer than 40, fewer than 30, 5-25, etc.). Switching circuitry (sometimes referred to as multiplexer circuitry) that is controlled by control circuitry 16 can be located before and/or after each coil 26 and/or before and/or after the other components of output circuit 55 and can be used to switch desired sets of one or more coils 26 (desired output circuits 55) into or out of use. For example, if it is determined that device 28 is located in location 52 of FIG. 2, the coil(s) overlapping device 28 at location 52 may be activated during wireless power transmission operations while other coils 26 (e.g., coils not overlapped by device 28 in this example) are turned off.

During wireless power transmission operations, transistors in inverter 24 are controlled using AC control signals from gate driver 60. Control circuitry 16 uses control path 70 to control gate driver 60 to drive the gates of the transistors in inverter 24 with control signals having a selected duty cycle. The duty cycle of these control signals and therefore the duty cycle of the drive signals applied by inverter 24 to coil 26 and the resulting duty cycle of the corresponding wireless power signals produced by coil 26 can be adjusted dynamically. Other than performing duty cycle control, the inverter may also be adjusted (modulated) using phase-shift control and/or inverter input voltage amplitude modulation.

Wireless power receiving device 28 has wireless power receiving circuitry 40. Circuitry 40 includes rectifier circuitry 44 (e.g., a synchronous rectifier controlled by signals from control circuitry 34) that converts received alternating-current signals from coil 42 (e.g., wireless power signals received by coil 42) into direct-current (DC) power signals for battery charger circuitry 68 and other input-output devices 32 (FIG. 1). A power circuit such as battery charger circuitry 68 (e.g., a battery charging integrated circuit or other power management integrated circuit or integrated circuits) receives power from rectifier circuitry 44 and regulates the flow of this power to battery 30. Control circuitry 34 (e.g., control circuitry in a battery charging integrated circuit and/or separate control circuitry) adjusts operating parameters for charger circuitry 68. For example, control circuitry 34 supplies control signals to charger circuitry 68 that adjust the current draw and therefore the power draw of charger circuitry 68 from rectifier circuitry 44 in real time. Battery charger circuitry 68 includes power converter circuitry such as one or more switched capacitor converters and/or one or more buck converters. Control circuitry 34 provides control signals to control the duty cycle(s) of the power converter circuitry in battery charger circuitry 68.

Control circuitry 34 may measure current and/or voltage at one or more points within rectifier circuitry 44 (over path 74), at one or more points within battery charger circuitry 68 (over path 78), and/or at paths 66 between rectifier circuitry 44 and battery charger circuitry 68 (over path 76). Control circuitry 34 measures the current at battery 30 (I_{BATT}) and the voltage across battery 30 (V_{BATT}) over path 80. Control circuitry 34 gathers these measurements using current sensors, voltage sensors, or other measurement circuitry 38 of FIG. 1.

Control circuitry 16 in device 12 may be coupled to a wireless receiver circuit such as feedback receiver 71 in wireless transceiver circuitry 18 (e.g., over feedback control path 65). Control circuitry 34 in device 28 may be coupled to wireless transmitter circuit such as feedback transmitter 73 in wireless transceiver circuitry 36 (e.g., over feedback control path 63). Transceiver circuitry 18 and 36 may support wireless data transmission between devices 12 and 28. For example, transceiver circuitry 36 may provide feedback data to transceiver circuitry 18 so that control circuitry 16 can make adjustments to the wireless power transmitted to device 28 (e.g., to meet the charging demands of battery 30). In one suitable arrangement, transceiver circuitry 36 and 18 may communicate using coils 26 and 42 (e.g., using in-band communications). In another suitable arrangement, transceiver circuitry 36 and 18 communicate using out-of-band communications. Device 12 includes one or more capacitor electrodes (plates) 59 (e.g., a first capacitor electrode 59-1, a second capacitor electrode 59-2, etc.) coupled to feedback receiver 71 and device 28 includes one or more capacitor electrodes 61 (e.g., a first capacitor electrode 61-1, a second capacitor electrode 61-2, etc.) coupled to feedback transmitter 73 for performing out-of-band communications.

Feedback transmitter 73 includes modulation circuitry such as modulator 69 and drive circuitry such as driver 67. Feedback receiver 71 includes signal processing circuitry such as signal processor 77 and demodulation circuitry such as demodulator 75. Control circuitry 34 generates feedback control signals FDBK based on measurements gathered over paths 74, 76, 78, and/or 8. Feedback control signals FDBK may, for example, identify the voltage and current at various points within wireless power receiving circuitry 40, paths 66, battery charger circuitry 68, and/or battery 30. Control circuitry 34 provides feedback control signals FDBK to modulator 69 in feedback transmitter 73. Modulator 69 modulates feedback control signals FDBK and provides the modulated signals to driver 67. Modulator 69 may use an ASK modulation scheme such as on-off keying (OOK) modulation to modulate feedback control signals FDBK, as one example. Driver 67 drives one or more capacitor electrodes 61 using the modulated signals, which capacitively couple to one or more capacitor electrodes 59 on device 12 (as shown by near-field capacitive signals 57). Signal processor 77 receives the capacitively coupled signals from capacitor electrodes 59 and performs signal processing operations on the received signals. Demodulator 75 demodulates the received signals to recover feedback signals FDBK. Demodulator 75 provides feedback signals FDBK to control circuitry 16 over path 65. Control circuitry 16 adjusts the duty cycle of inverter 24 (using gate driver 60) to adjust the duty cycle of the wireless power transmitted by coil 26.

In this way, control circuitry 34 on device 28 provides active feedback to device 12 to control device 12 to adjust wireless power transfer based on the present demands of battery 30 and/or other circuitry on device 28. Control circuitry 16 adjusts the duty cycle of the transmitted wireless power based on voltage and/or current measurements gathered using control circuitry 34 on wireless power receiving device 28. For example, when control circuitry 34 detects that battery 30 requires greater wireless power transfer from device 12 (e.g., based on the gathered voltage and/or current measurements), control circuitry 16 on device 12 may increase the duty cycle of inverter 24 to compensate (e.g., based on information in feedback signals FDBK received from device 28). Similarly, when control circuitry 34 detects that battery 30 requires less wireless power transfer from device 12, control circuitry 16 can decrease the duty cycle of inverter 24 to compensate. In general, feedback signals FDBK can be used to adjust the duty cycle of inverter 24 to optimize charging efficiency for any desired load power to be delivered to the load of device 28 (charger 68 and battery 30 in the example of FIG. 3).

The output voltage V_{RECT} of rectifier 44 may be greater than is required for charging battery 30. Battery charger circuitry 68 includes power converter circuitry (e.g., DC/DC converter circuitry) that converts (divides) rectifier output voltage V_{RECT} to a lesser voltage V_{BATT} that is provided to battery 30 (sometimes referred to herein as charging voltage V_{BATT}). In some scenarios, the battery charger circuitry includes a buck converter for producing charging voltage V_{BATT}. However, buck converters include inductors that limit their charging efficiency, which serves to limit the maximum efficiency of the battery charger circuitry and thus the wireless charging efficiency of the entire wireless charging system. In order to maximize the efficiency of battery charger circuitry 68 and thus wireless power system 8, battery charger circuitry 68 includes one or more switched capacitor converters for producing voltage V_{BATT}. Switched capacitor converters do not include inductors and operate with greater efficiency than buck converters. Battery charger circuitry 68 thereby operates with greater maximum wireless charging efficiency relative to scenarios where the battery charger circuitry includes only buck converters.

In general, in-band communications (e.g., over coils 26 and 42) and/or out-of-band communications (e.g., over capacitor electrodes 59 and 61) may be used to convey feedback signals FDBK from control circuitry 34 to control circuitry 16 for adjusting the duty cycle of inverter 24. However, in-band communications are relatively slow and may not be performed at a speed sufficient to meet the operating requirements of the switched capacitor converter(s) in battery charger circuitry 68. In addition, in-band communications can limit wireless power transfer between coils 26 and 42 and are sensitive to electromagnetic noise. Capacitive out-of-band communications (e.g., over capacitor electrodes 59 and 61) supports higher feedback speeds (data rates) and is less-susceptible to electromagnetic noise than in-band communications over coils 26 and 42. Conveying feedback signals FDBK over capacitor electrodes 59 and 61 (using feedback transmitter 73 and feedback receiver 71) allows the duty cycle of inverter 24 to be adjusted (e.g., to meet the load power requirements of device 28 while optimizing charging efficiency) at a speed that is sufficient to meet the operating requirements of the switched capacitor converter(s) in battery charger circuitry 68.

The example of FIG. 3 is merely illustrative. If desired, transceiver circuitry 18 in device 12 may convey wireless data to device 28 over an in-band communications link (e.g., over coils 26 and 42 using FSK modulation) while device 12 receives feedback signals FDBK over capacitor electrodes 59. In another suitable arrangement, transceiver circuitry 18 includes a transmitter that conveys wireless data to device 28 over an out-of-band communications link (e.g., over one or more capacitor electrodes 59) while device 12 receives feedback signals FDBK over other capacitor electrodes 59. In this scenario, transceiver circuitry 36 on device 28 includes receiver circuitry coupled to capacitor electrodes 61 for receiving the wireless data from device 12. Device 12 may include a single capacitor electrode 59 and/or device 28 may include a single capacitor electrode 61 if desired.

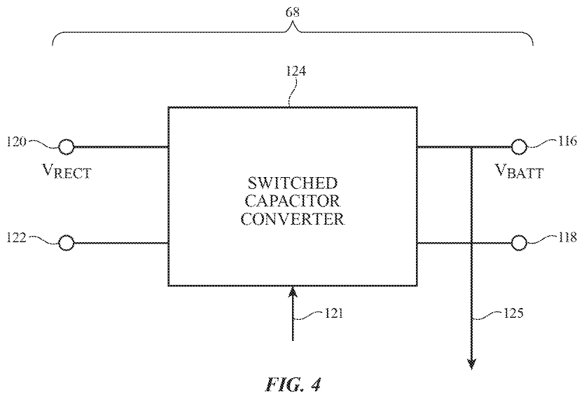

FIG. 4 is a diagram showing how battery charger circuitry 68 may include a switched capacitor converter that produces charging voltage V_{BATT} for charging battery 30. As shown in FIG. 4, battery charger circuitry 68 includes switched capacitor converter 124. Switched capacitor converter 124 is coupled to input terminals 120 and 122 and output terminals 116 and 118. Terminals 120 and 122 are coupled rectifier circuitry 44 over paths 66 (FIG. 3). Output terminals 116 and 118 are coupled to battery 30.

Rectifier circuitry 44 provides rectifier output voltage V_{RECT} at terminal 120. Switched capacitor converter 124 includes one or more capacitors and switching circuitry. The switching circuitry includes transistors having gate terminals controlled by control signals received over control path 121. Control circuitry 34 (FIG. 3) provides control signals having a desired duty cycle over path 121 to control the switching circuitry in switched capacitor converter 124. Toggling the switching circuitry in converter 124 produces charging voltage V_{BATT} at terminal 116 that is a fraction of rectifier output voltage V_{RECT} (e.g., battery charger circuitry 68 uses the output voltage of converter 124 is used as charging voltage V_{BATT}).

Switched capacitor converter 124 may be a 2:1 converter (e.g., a converter that produces an output voltage that is one-half of its input voltage), a 3:1 converter (e.g., a converter that produces an output voltage that is one-third of its input voltage), a 4:1 converter (e.g., a converter that produces an output voltage that is on-fourth of its input voltage), or may divide its input voltage by any other desired factor. In this way, switched capacitor converter 124 may convert a relatively high voltage provided by rectifier circuitry 44 into a lower voltage suitable for charging battery 30. For example, in a scenario where the input voltage is 8V and switched capacitor converter is a 2:1 converter, switched capacitor converter 124 produces an output voltage of 4V for charging battery 30. Control circuitry 34 may sample (measure) the output voltage and/or the output current of switched capacitor converter 124 over path 125 (e.g., one of paths 78 of FIG. 3).

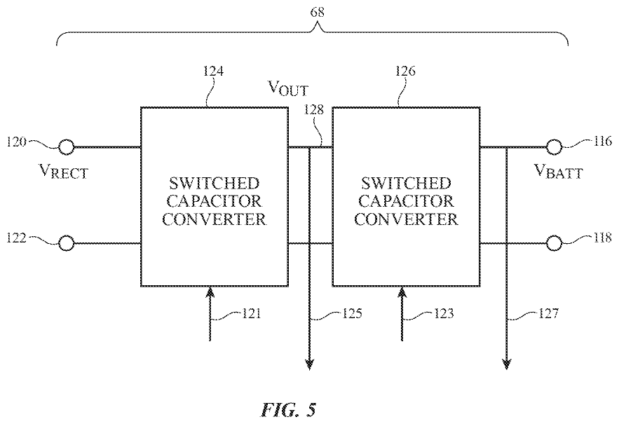

In the example of FIG. 4, battery charger circuitry 68 includes only a single switched capacitor converter. This is merely illustrative. If desired, battery charger circuitry 68 may include multiple stages of converter circuits such as two stages of switched capacitor converters. FIG. 5 is a diagram of battery charger circuitry 68 having two stages of switched capacitor converters.

In the example of FIG. 5, battery charger circuitry 68 includes a first switched capacitor converter 124 and a second switched capacitor converter 126 coupled in series between input terminals 120/122 and output terminals 116/118. Control circuitry 34 (FIG. 3) provides control signals having a desired duty cycle over path 123 to control the switching circuitry in switched capacitor converter 126. Switched capacitor converter 124 divides rectifier output voltage V_{RECT} received at terminal 120 to produce converter output voltage V_{OUT} on path 128. Switched capacitor converter 126 further divides converter voltage V_{OUT} on path 128 to produce charging voltage V_{BATT} at output terminal 116 (e.g., battery charger circuitry 68 uses the output voltage of converter 126 as charging voltage V_{BATT}).

Switched capacitor converter 126 may be a 2:1 converter, a 3:1 converter, a 4:1 converter, or may divide voltage V_{OUT} by any other desired factor. Including multiple switched capacitor converters in battery charger circuitry 68 allows the battery charger to further divide the rectifier output voltage V_{RECT} (e.g., so that battery 30 can be charged using relatively high voltages from rectifier 44). For example, in a scenario where rectifier output voltage V_{RECT} is 16V and switched capacitor converters 124 and 126 are both 2:1 converters, switched capacitor converter 124 produces a voltage V_{OUT} of 8V on path 128 and switched capacitor converter 126 produces a charging voltage V_{BATT} of 4V at terminal 116 for charging battery 30. Control circuitry 34 may sample (measure) voltage V_{OUT} and/or current on path 128 over path 125. Control circuitry 34 may measure charging voltage V_{BATT} and/or current at terminal 116 over path 127.

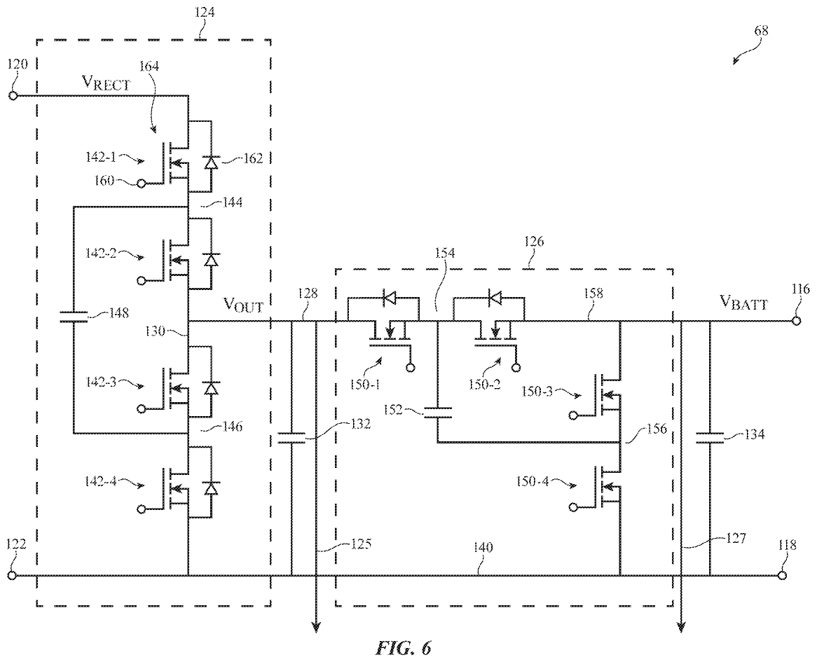

FIG. 6 is a circuit diagram of battery charger 68 having series-coupled switched capacitor converters 124 and 126. As shown in FIG. 6, battery charger 68 has a reference (e.g., ground) line 140 coupled between input terminal 122 and output terminal 118. Switched capacitor converter 124 includes multiple switching circuits 142 (e.g., a first switching circuit 142-1, a second switching circuit 142-2, a third switching circuit 142-3, and a fourth switching circuit 142-4). Each switching circuit 142 includes a corresponding transistor 164 (e.g., a metal-oxide-semiconductor field-effect transistor) and a corresponding diode 162 coupled between the source/drain terminals of the transistor. Transistor 164 has a gate terminal 160 that receives control signals from control circuitry 34 (FIG. 3) over control path 121 (FIG. 4). Similarly, switched capacitor converter 126 includes multiple switching circuits 150 (e.g., a first switching circuit 150-1, a second switching circuit 150-2, a third switching circuit 150-3, and a fourth switching circuit 150-4). Each switching circuit 150 includes a corresponding transistor and diode similar to transistor 164 and diode 162 of switching circuits 142. The transistors in switching circuits 150 each have a gate terminal that receives control signals from control circuitry 34 (FIG. 3) over control path 123 (FIG. 4).

Switching circuit 142-1 in switched capacitor converter 124 is coupled between input terminal 120 and circuit node 144. Switching circuit 142-2 is coupled between circuit node 144 and circuit node 130. Switching circuit 142-3 is coupled between circuit node 130 and circuit node 146. Switching circuit 142-4 is coupled between circuit node 146 and reference line 140. Switched capacitor converter 124 includes a capacitor 148 coupled between circuit nodes 144 and 146. Path 128 couples circuit node 130 to switched capacitor converter 126.

Switching circuit 150-1 in switched capacitor converter 126 is coupled between path 128 and circuit node 154. Switching circuit 150-2 is coupled between circuit node 154 and path 158. Switching circuit 150-3 is coupled between path 158 and circuit node 156. Switching circuit 150-4 is coupled between circuit node 156 and reference line 140. Switched capacitor converter 126 includes a capacitor 152 coupled between circuit nodes 154 and 156. Path 158 couples switched capacitor converter 126 to output node 116. Battery charger 68 of FIG. 6 includes a first decoupling capacitor 132 coupled between path 128 and reference line 140 and a second decoupling capacitor 134 coupled between path 158 and reference line 140. Decoupling capacitors 132 and 134 may smooth the voltages provided on paths 128 and 158, respectively. Decoupling capacitor 132 and/or 134 may be omitted if desired. Battery charger circuitry 68 may include additional decoupling capacitors if desired.

As shown in FIG. 6, switched capacitor converter 124 receives rectifier output voltage V_{RECT} from rectifier 44 (FIG. 3) over input terminal 120. Switched capacitor converter 124 functions as a voltage divider that divides rectifier output voltage V_{RECT} to produce output voltage V_{OUT} on path 128. Switched capacitor converter 126 functions as a voltage divider that divides voltage V_{OUT} to produce charging voltage V_{BATT} on output terminal 116. Charging voltage V_{BATT} is subsequently used to charge battery 30 (FIG. 3). In the example of FIG. 6, switched capacitor converters 124 and 126 are each 2:1 converters that divide their input voltages by a factor of two.

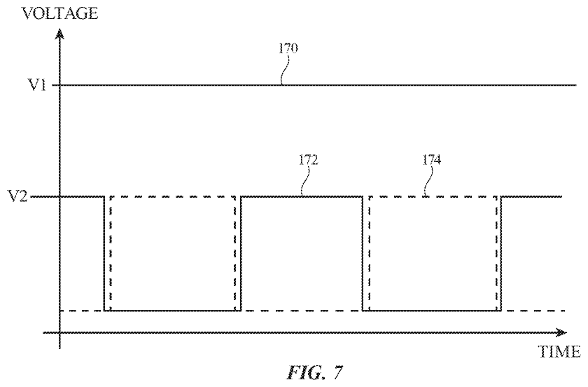

FIG. 7 is a plot of voltage as a function of time that illustrates the operation of switched capacitor converter 124. As shown in FIG. 7, line 170 represents the input voltage provided to switched capacitor converter 124 at terminal 120 (e.g., rectifier output voltage V_{RECT} having magnitude V1). Control circuitry 34 (FIG. 3) turns on switching circuits 142-1 and 142-3 (while switches 142-2 and 142-4 are turned off) for half of the duty cycle of switched capacitor converter 124 and turns on switching circuits 142-2 and 142-4 (while switches 142-1 and 142-3 are turned off) for the remaining half of the duty cycle. The duty cycle of switched capacitor converter 124 may be, for example, 250 kHz, 300 kHz, 500 kHz, between 200 kHz and 600 kHz, between 250 kHz and 500 kHz, greater than 600 kHz, less than 200 kHz, etc.

While switching circuits 142-1 and 142-3 are turned on, current flows from terminal 120, through switch 142-1, circuit node 144, capacitor 148, circuit node 146, and switch 142-3 to circuit node 130. Capacitor 148 accumulates charge from this current such that a voltage having divided magnitude V2 is produced at terminal 130 (e.g., where magnitude V2 is one-half of magnitude V1). Curve 172 of FIG. 7 illustrates the voltage produced on circuit node 130 while switching circuits 142-1 and 142-3 are turned on. While switching circuits 142-2 and 142-4 are turned on, current flows from reference line 140, through switch 142-4, circuit node 146, capacitor 148, circuit node 144, and switch 142-2 to circuit node 130. Capacitor 148 accumulates charge from this current such that a voltage having divided magnitude V2 is produced at terminal 130 (e.g., where magnitude V2 is one-half of magnitude V1). Dashed curve 174 of FIG. 7 illustrates the voltage produced on circuit node 130 while switching circuits 142-2 and 142-4 are turned on.

By toggling the switching circuits in this way, voltage V_{OUT} on circuit node 130 and line 128 (FIG. 6) is provided at magnitude V2 (e.g., half of the magnitude V1 of rectifier output voltage V_{RECT}). Switching circuits 150 in switched capacitor converter 126 of FIG. 6 may also be controlled in this way to produce a battery charging voltage V_{BATT} having half of the magnitude of voltage V_{OUT} and one-quarter the magnitude of rectifier output voltage V_{RECT}. This may allow rectifier 44 to produce relatively high rectified voltages (e.g., 12V, 16V, between 12V and 16V, greater than 16V, between 9V and 16V, greater than 9V, greater than 6V, etc.) even though relatively low charging voltages V_{BATT} are used to charge battery 30 (e.g., 3V, 2V, 4V, between 1V and 5V, etc.).

Control circuitry 34 measures voltage V_{OUT} and current on path 128 over path 125 and/or charging voltage V_{BATT} and current on path 158 over path 127. These voltages and currents may be identified in feedback control signal FDBK (FIG. 3) and may be used by control circuitry 16 in device 12 for adjusting the duty cycle of inverter 24. The example of FIG. 6 is merely illustrative. Switched capacitor converters 124 and 126 may include suitable circuitry for dividing rectifier output voltage V_{RECT} by other factors if desired. Battery charger circuitry 68 may include more than two switched capacitor circuits coupled in series between rectifier 44 and battery 30 (FIG. 3) if desired.

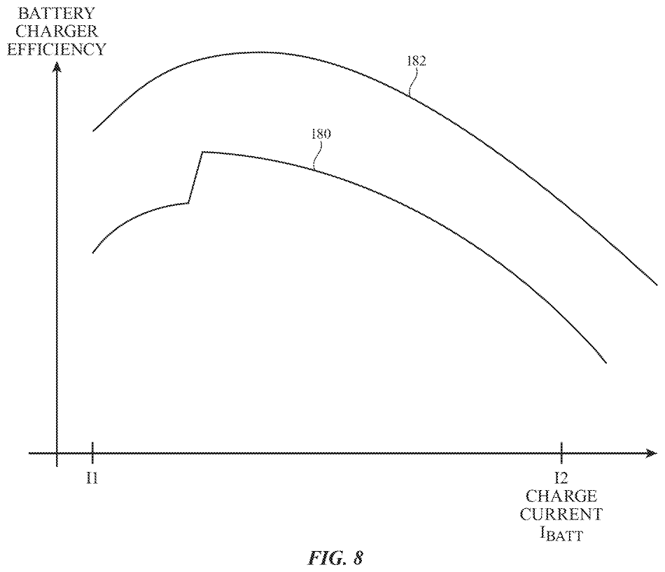

FIG. 8 is a plot of battery charger efficiency as a function of charging current I_{BATT}. As shown in FIG. 8, curve 180 plots the efficiency of a battery charger without switched capacitor converters (e.g., a battery charger based on a buck converter). The battery charger efficiency in this scenario is relatively low across charging currents I_{BATT} (e.g., less than 93%). The battery charger efficiency deteriorates further (e.g., to less than 90%) for relatively high rectifier output voltages V_{RECT} (e.g., voltages greater than 9V). Curve 182 plots the efficiency of battery charger 68 having one or more switched capacitor converters. As shown by curve 182, the switched capacitor converter exhibits greater efficiency relative to buck converters for all charge currents I_{BATT} from current I1 (e.g., 1 A, 2 A, between 0.5 A and 2.5 A, between 3.5 A and 4 A, etc.) to current I2 (e.g., 6 A, 8 A, 9 A, between 5 A and 10 A, between 4 and 4.5 A, etc.), even for relatively high rectifier output voltages V_{RECT} such as voltages greater than 9V.

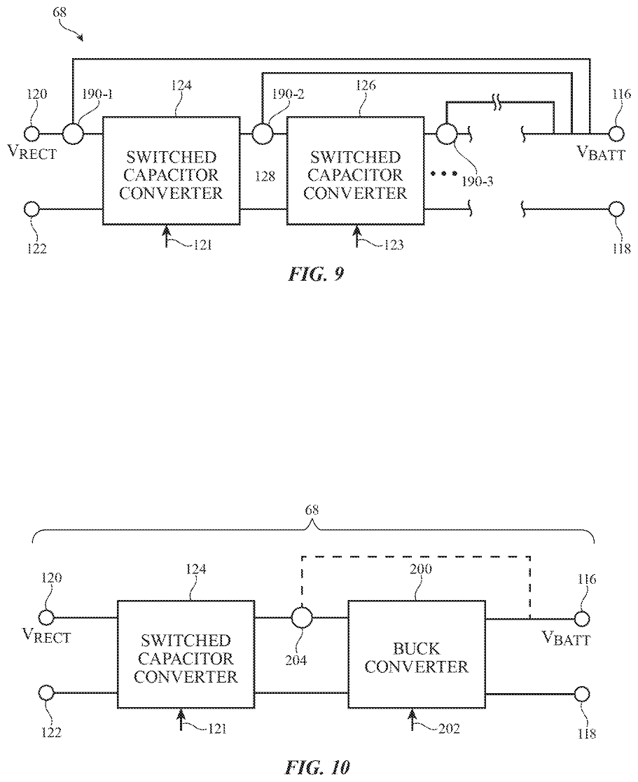

If desired, one or more of the switched capacitor converters in battery charger circuitry 68 may be selectively activated or bypassed by control circuitry 34. FIG. 9 is a diagram showing how one or more of the switched capacitor converters in battery charger circuitry 68 may be selectively activated or bypassed by control circuitry 34. As shown in FIG. 9, battery charger circuitry 68 may include bypass switches 190 (e.g., a first bypass switch 190-1, a second bypass switch 190-2, a third bypass switch 190-3, etc.) coupled to the input of each switched capacitor converter.

Control circuitry 34 controls switches 190 to bypass (deactivate) one or more of the switched capacitor converters so that the bypassed switched capacitor converters do not further divide the voltage provided to their inputs. For example, control circuitry 34 may control switch 190-1 to couple input terminal 120 to output terminal 116, thereby bypassing all of the switched capacitor converters in battery charger circuitry 68 so that rectifier output voltage V_{RECT} is used to charge battery 30. As another example, control circuitry 34 may control switch 190-2 so that only switched capacitor converter 124 is used to divide rectifier output voltage V_{RECT}, whereas all of the other switched capacitor converters are deactivated (e.g., converter output voltage V_{OUT} of FIG. 6 may be used as charging voltage V_{BATT}). In this way, control circuitry 34 can dynamically adjust the number of times rectifier output voltage V_{RECT} is divided before being used to charge battery 30. As an example, if rectifier output voltage V_{RECT} is received at a relatively low voltage (e.g., 4V), this voltage may be suitable for charging battery 30 without further conversion and each of the switched capacitor converters in battery charger circuitry 68 may be bypassed. Bypass switches 190 may be used to bypass any desired switched capacitor converters in battery charging circuitry 68.

If desired, battery charger circuitry 68 may include a buck converter in addition to one or more switched capacitor converters. FIG. 10 is a diagram of battery charger circuitry 68 in an example where switched capacitor converter 124 is coupled in series with a buck converter such as buck converter 200 between rectifier 44 and battery 30 (FIG. 3). As shown in FIG. 10, buck converter 200 further divides the output voltage of switched capacitor converter 124 to produce charging voltage V_{BATT}. Buck converter 200 includes switching circuitry that is controlled using control signals received from control circuitry 34 over path 202. The control signals may actively adjust the duty cycle of the switching circuitry in buck converter 200.

Buck converter 200 may perform voltage conversion to meet transient load requirements in device 28 more effectively than a switched capacitor converter, for example. If desired, optional bypass switch 204 may be interposed between switched capacitor converter 124 and buck converter 200. Control circuitry 34 may use switch 204 to bypass buck converter 200 (e.g., to charge battery 30 using the output voltage from switched capacitor converter 124 when no transient load requirements are present). If desired, a bypass switch (not shown) may be coupled to the input of switched capacitor converter 124 to bypass each of the converters in battery charger circuitry 68.

FIG. 11 is a diagram of battery charger circuitry 68 in an example where switched capacitor converter 126 and buck converter 200 are coupled in parallel between switched capacitor converter 124 and battery 30. In the example of FIG. 11, switching circuitry such as switch 214 is coupled to the output of switched capacitor converter 124. Buck converter 200 is coupled to switch 214 over paths 210. Switched capacitor converter 126 is coupled to switch 214 over paths 212. Buck converter 200 and switched capacitor converter 126 are coupled in parallel between switch 214 and battery 30. Control circuitry 34 (FIG. 3) controls switch 214 to selectively activate one of converters 200 or 126 at a given time. For example, when no transient load requirements are present in device 28, control circuitry 34 may control switch 214 to couple switched capacitor converter 124 to paths 212 and switched capacitor converter 126. Switched capacitor converter 126 subsequently divides the voltage output by converter 124 for charging battery 30.

When transient load requirements are present in device 28, control circuitry 34 may control switch 214 to couple switched capacitor converter 124 to paths 210 and buck converter 200. Buck converter 200 subsequently divides the voltage output by converter 124 for charging battery 30. In practice, transient load requirements may arise when battery charger circuitry 68 is being used to power portions of device 28 other than battery 30 (e.g., input-output devices 32 of FIG. 1). In the example of FIG. 11, a switch such as switch 216 is coupled to output terminal 116 of battery charger circuitry 68. Switch 216 is placed in a first state at which terminal 116 is coupled to switch terminal 222 when battery 30 is to be charged using battery charger circuitry 68. Switch 216 is placed in a second state at which terminal 116 is coupled to terminal 220 and system load 224 when battery 30 is not being charged. System load 224 may exhibit transient load requirements that are handled by buck converter 200 (e.g., control circuitry 34 may control switch 216 to couple terminal 216 to terminal 220 and may couple converter 124 to buck converter 200 when transient load requirements are present in system load 224). If desired, bypass switches (not shown) may be coupled to the inputs of switched capacitor converter 124, switched capacitor converter 126, and/or buck converter 200.

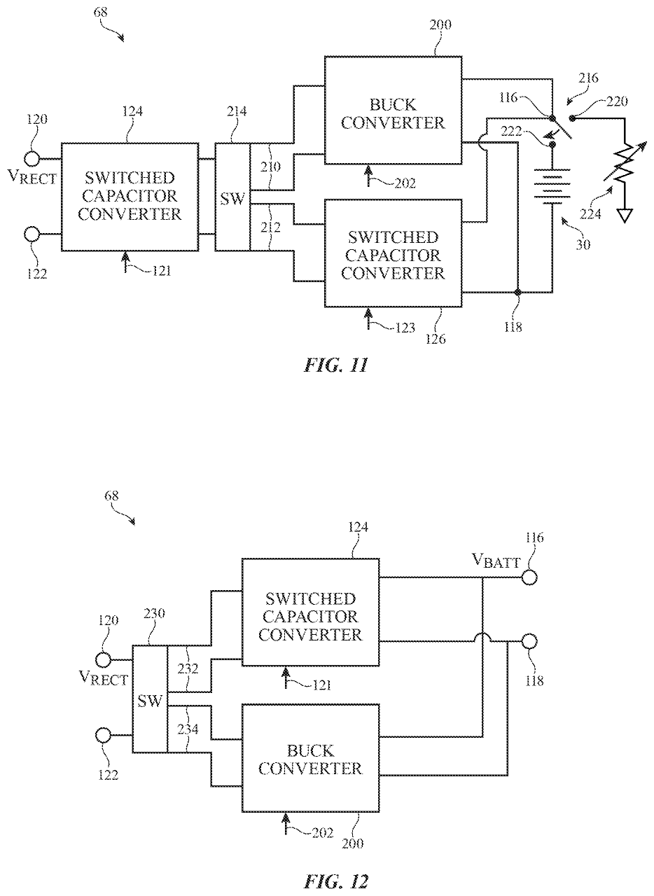

FIG. 12 is a diagram of battery charger circuitry 68 in an example where switched capacitor converter 126 and buck converter 200 are coupled in parallel between rectifier 44 and battery 30 (FIG. 3). In the example of FIG. 12, switching circuitry such as switch 230 is coupled to input terminals 120 and 122. Buck converter 200 is coupled to switch 230 over paths 234. Switched capacitor converter 124 is coupled to switch 230 over paths 232. Buck converter 200 and switched capacitor converter 124 are coupled in parallel between switch 230 and battery 30. Control circuitry 34 (FIG. 3) controls switch 214 to selectively activate one of converters 200 or 124 at a given time. For example, when no transient load requirements are present in device 28, control circuitry 34 may control switch 230 to couple switched capacitor converter 124 to rectifier 44. When transient load requirements are present in device 28, control circuitry 34 may control switch 230 to couple buck converter 200 to rectifier 44. If desired, bypass switches (not shown) may be coupled to the inputs of switched capacitor converter 124 and/or buck converter 200.

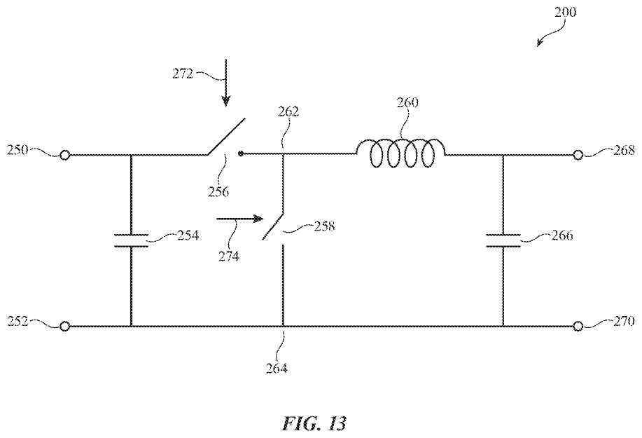

FIG. 13 is an exemplary circuit diagram of buck converter 200 of FIGS. 10-12. As shown in FIG. 13, buck converter 200 has input terminals 250 and 252 and output terminals 268 and 270. Reference line 264 is coupled between terminals 252 and 270. Capacitor 254 is coupled between terminal 250 and reference line 264. A first switch 256 is coupled between terminal 250 and circuit node 262. A second switch 258 is coupled between circuit node 262 and reference line 264. An inductor such as inductor 260 is coupled between circuit node 262 and terminal 268. A capacitor such as capacitor 266 is coupled between terminal 268 and reference line 264. Switch 258 is controlled by control signal 272 and switch 258 is controlled by control signal 274 (provided over control path 202 of FIGS. 10-12). Control signal 272 toggles switch 256 using a given portion of the duty cycle of converter 200 and control signal 274 toggles switch 258 using the remaining portion of the duty cycle of converter 200. Buck converter 200 produces an output voltage on terminal 268 that is a fraction of the input voltage received at terminal 250. Inductor 260 allows buck converter 200 to respond to transient load requirements but also introduces relatively high losses in charger efficiency. The duty cycle can be adjusted in real time to adjust the magnitude of the output voltage for a given input voltage. The example of FIG. 13 is merely illustrative and, in general, any desired buck converter architecture may be used for implementing buck converter 200.

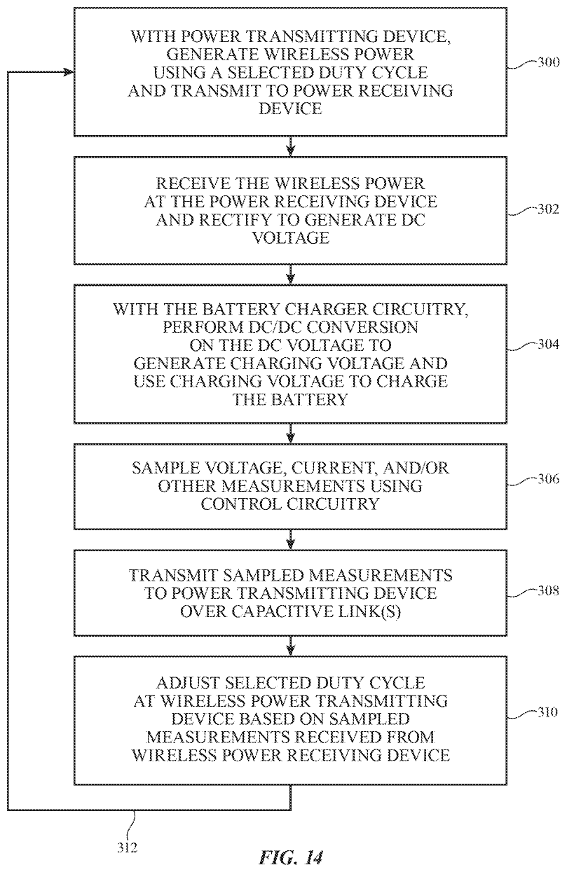

FIG. 14 is a flow chart of illustrative operations involved in controlling system 8. Initially, a user places device 28 on surface 50 of device 12 (FIG. 2). Device 12 may contain a foreign object detection system (e.g., a detection circuit coupled to coil 26 or a detection system using a separate set of coils) that detects when device 28 has been placed on surface 50. In response to detection that device 28 is present in the vicinity of device 12, device 12 and device 28 establish a wireless communications link (e.g., using in-band communications and coils 26 and 42 and/or out-of-band communications using capacitor electrodes 59 and 61 of FIG. 3). During subsequent operations, device 12 uses the communications link to send information to device 28. Device 28 uses the communications link to send information (e.g., feedback signals FDBK) to device 12. The information that is conveyed over the communications link(s) includes control commands, sensor data, required power settings, operating parameters, and/or other information.

The communications link allows devices 28 and 12 to establish initial operating conditions. For example, the communications link allows device 12 to inform device 28 of the power delivery capabilities of device 12 (e.g., “current maximum available power is 5.6 W”). The communications link also allows device 28 to receive this information from device 12 and to acknowledge the received information. The link allows devices 28 and 12 to identify each other and confirm that control operations can be performed securely.

Device 28 can set initial operating parameters. For example, battery charger circuitry 68 can use information on the current charge status of battery 30 or other information to establish a desired level of power to receive from rectifier 44 and to use in charging battery 30. If battery 30 is depleted and should be rapidly charged, the desired operating power for circuitry 68 (sometimes referred to as load power or load demand) may be set to be equal to the maximum available wireless power from device 12. If battery 30 is nearly full, the desired load power can be set to a lower level (e.g., 1.0 W). Battery charger circuitry 68 can monitor the state of battery 30 in real time (e.g., by gathering voltage and current measurements over paths 74, 76, 78, and/or 80 of FIG. 3) can update the current desired level of power for battery charger circuitry 68 accordingly.

After the wireless communications link has been established between devices 12 and 28 and desired authentication operations have been satisfactorily performed, wireless charging can begin. At step 300, control circuitry 16 on device 12 controls inverter 24 to generate wireless power signals using a selected duty cycle (e.g., a duty cycle selected to meet the load demand of device 28 as identified by wireless data received from device 28 over the wireless communications link). Coil 26 transmits the wireless power signals at the selected duty cycle.

At step 302, coil 42 on device 28 receives the wireless power signals. Rectifier 44 rectifies the received wireless power signals to generate a DC voltage (e.g., rectifier output voltage V_{RECT} of FIGS. 3-6 and 9-13).

At step 304, battery charger circuitry 68 on device 28 converts (divides) rectifier output voltage V_{RECT} to generate charging voltage V_{BATT}. Charging voltage V_{BATT} is used to charge battery 30 and/or to power other components in device 28. This conversion is performed with relatively high charger efficiency (see, e.g., curve 182 of FIG. 8) due to the use of switched capacitor converter(s) in battery charger circuitry 68.

At step 306, control circuitry 34 on device 28 gathers signal measurements from rectifier circuitry 44, battery charger circuitry 68, paths 66 between rectifier circuitry 44 and battery charger circuitry 68, and/or battery 30. For example, control circuitry 34 may measure rectifier output voltage V_{RECT}, voltage V_{OUT} (FIG. 6), charging voltage V_{BATT}, current I_{BATT}, and/or any other desired voltages or currents over paths 74, 76, 78, or 80 of FIG. 3. Control circuitry 34 generates feedback signals FDBK that include information identifying these measurements.

At step 308, feedback transmitter 73 of device 28 transmits feedback signals FDBK to feedback receiver 71 of device 12 over capacitive link 57 (FIG. 3). Feedback transmitter 73 may transmit feedback signals FDBK over one capacitor electrode 61, two capacitor electrodes 61, or more than two capacitor electrodes 61. If desired, one or more capacitor electrodes 61 may be used to receive feedback signals FDBK from device 12 (e.g., capacitor electrodes 61-1 and 59-1 of FIG. 3 may be used to convey feedback signals FDBK from device 28 to device 12 while capacitor electrodes 61-2 and 59-2 are used to convey wireless data from device 12 to device 28). Transmitting feedback signals FDBK over capacitive link 57 is faster and involves less electromagnetic noise relative to scenarios where the feedback signals are transmitted over coil 42. Feedback receiver 71 demodulates received feedback signals FDBK (e.g., using demodulator 75) and provides the feedback signals to control circuitry 16 on device 12. If desired, control circuitry 34 on device 28 may adjust battery charger circuitry 68 based on these measurements (e.g., to bypass one or more switched capacitor converters, to bypass a buck converter, to switch the buck converter into use, to switch a desired number of switched capacitor converters into use, to adjust the duty cycle of the buck converter, etc.).

At step 310, control circuitry 16 adjusts the selected duty cycle of the control signals provided over path 70 based on the feedback signals FDBK received over capacitive link 57 (e.g., based on voltage and/or current measurements in device 28). This adjusts the duty cycle of the drive signals supplied by gate driver 60 to inverter 24, thereby adjusting the corresponding duty cycle of the wireless power signals supplied by inverter 24 to coil 26 and the corresponding duty cycle of the wireless power signals transmitted from device 12 to device 28.

Processing subsequently loops back to step 300 (as shown by arrow 312) and device 12 transmits wireless power using the newly-selected duty cycle. In this way, device 28 controls device 12 to update the duty cycle of the transmitted wireless power based on the current operating conditions and load power of device 28. Capacitive link 57 allows feedback signals FDBK to be received and processed by device 12 rapidly enough to meet the operating requirements of the switched capacitor converter(s) in battery charger circuitry 68. The switched capacitor converters allow device 28 and thus charging system 8 to exhibit optimal charging efficiency for relatively high rectifier output voltages V_{RECT} (e.g., voltages having a magnitude of 9V or higher) across all charging currents I_{BATT} of interest.

Capacitor electrodes 59 of device 12 (FIG. 3) may be formed at any desired locations on device 12. For example, a single capacitor electrode 59 may be located at charging surface 50 (FIG. 2) or multiple capacitor electrodes 59 may be arranged in an array at charging surface 50. The array of capacitor electrodes may be arranged in a rectangular grid of rows and columns (e.g., having the same spacing or different spacing from that of coils 26 on charging surface 50) or in any other desired pattern (e.g., a hexagonal pattern, a non-uniform pattern, a random pattern, etc.). The capacitor electrodes may be formed on a dielectric layer over coils 26, may be formed in the same plane as coils 26, or may be formed on a dielectric layer under coils 26. After device 28 has been placed on charging surface 50, device 12 may selectively activate (e.g., switch into use) only those capacitor electrodes 59 that are overlapping a corresponding capacitor electrode 61 on device 12 or may activate any desired set of electrodes 59 (e.g., some or all of electrodes 59). If desired, device 12 may activate only those capacitor electrodes that are adjacent to active coil(s) 26 that are being used to transmit wireless power signals to device 28. If desired, device 12 may scan through different capacitor plates until a capacitor plate that is aligned with a corresponding capacitor plate 61 on device 28 is found.

Similarly, capacitor electrodes 61 may be located at any desired location on device 28. Capacitor electrodes 61 may be formed on a dielectric layer over coil 42, may be formed on a dielectric layer under coil 42, or may be formed within the same plane as coil 42. Capacitor electrodes 61 may be formed using conductive traces on a dielectric substrate, using conductive portions of a housing for device 28, using a conductive shield for coil 42, etc. Similarly, capacitor electrodes 59 of device 12 may be formed using conductive traces on a dielectric substrate, using conductive portions of a housing for device 12, using a conductive shield for coils 26, etc.

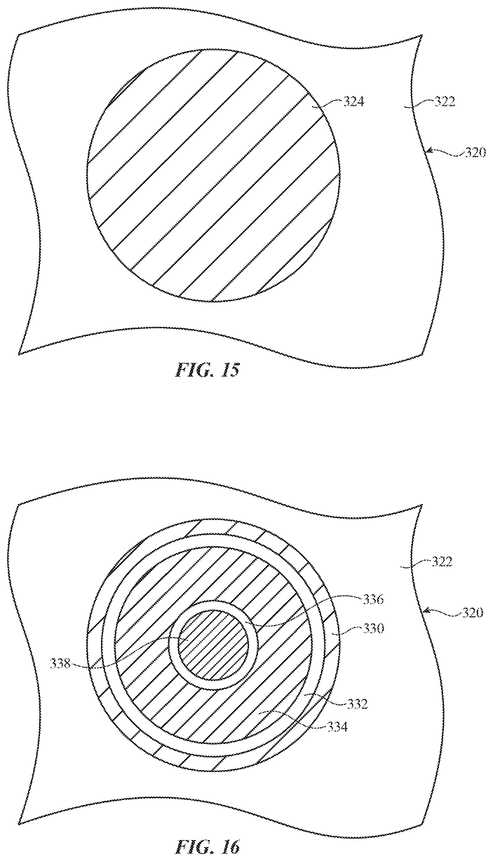

FIG. 15 is a top-down view of a capacitor electrode that may be used in forming capacitor electrodes 59 and/or 61 of FIG. 3. As shown in FIG. 15, capacitor electrode (plate) 324 is formed on surface 322 of dielectric substrate 320. In the example of FIG. 15, capacitor electrode 324 has a circular shape. This is merely illustrative. In general, capacitor electrode 324 may have any desired shape (e.g., a rectangular shape, a curved shape, and elliptical shape, a shape following a meandering path, a shape having straight and/or curved edges, etc.).

In scenarios where capacitor electrode 324 of FIG. 15 is used to form a given capacitor electrode 59 on device 12, surface 322 may be charging surface 50 of FIG. 2 (e.g., one or more coils 26 may be formed on substrate 320). In another suitable arrangement, coils 26 are formed on a separate substrate that is layered over or under substrate 320. Capacitor electrode 324 may completely overlap a corresponding coil 26, may partially overlap one or more coils 26, or may not overlap any coils 26 (e.g., the lateral area of capacitor electrode 324 may be laterally offset from the outline of each of coils 26). Capacitor electrodes 59 of FIG. 3 may be formed elsewhere on device 12 if desired.

In scenarios where capacitor electrode 324 of FIG. 15 is used to form a given capacitor electrode 61 on device 28, coil 42 may be formed on surface 322 of substrate 320. In another suitable arrangement, coil 42 is formed on a separate substrate that is layered over or under substrate 320. Capacitor electrode 324 may completely overlap a corresponding coil 42, may partially overlap coil 42, or may not overlap coil 42 (e.g., the lateral area of capacitor electrode 324 may be laterally offset from the outline of coil 42). Capacitor electrode 61 of FIG. 3 may be formed elsewhere on device 28 if desired.

In scenarios where device 12 includes multiple capacitor electrodes 59 and/or device 28 includes multiple capacitor electrodes 61, two or more of the capacitor electrodes may formed from concentric conductive structures. FIG. 16 is a top-down view of concentric capacitor electrodes that may be used in forming capacitor electrodes 59 and/or 61 of FIG. 3. As shown in FIG. 16, a capacitor electrode 338 and a ring-shaped capacitor electrode 330 are formed on surface 322 of substrate 320. Ring-shaped capacitor electrode 330 surrounds capacitor electrode 338. Conductive ring 334 is interposed between capacitor electrodes 338 and 330. Conductive ring 334 and ring-shaped capacitor electrode 330 are concentric about capacitor electrode 338. Conductive ring 334 is separated from capacitor electrode 330 by ring-shaped gap 332. Capacitor electrode 338 is separated from conductive ring 334 by ring-shaped gap 336. Conductive ring 334 may, for example, form an electromagnetic shield structure for devices 12 and/or 28. In the example of FIG. 16, capacitor electrodes 330 and 338 each have a circular shape. This is merely illustrative. In general, capacitor electrodes 338 and 330 may have any desired shapes.

Capacitor electrodes 330 and 338 of FIG. 16 may be used to form two capacitor electrodes 59 on device 12 (e.g., capacitor electrodes 59-1 and 59-2 of FIG. 3, respectively). Capacitor electrodes 330 and 338 may both overlap the same coil 26 in device 12, may each overlap portions of one or more different coils 26 in device 12, may not overlap any coils in device 26, electrode 338 may overlap a given coil 26 whereas electrode 330 does not overlap that coil 26, or electrode 330 may overlap a given coil 26 whereas electrode 338 does not overlap that coil 26. Similarly, capacitor electrodes capacitor electrodes 330 and 338 of FIG. 16 may be used to form two capacitor electrodes 61 on device 28 (e.g., capacitor electrodes 61-1 and 61-2 of FIG. 3, respectively). Capacitor electrodes 330 and 338 may both overlap the same coil 42 in device 28, may each overlap portions of one or more different coils 42 in device 28, may not overlap any coils in device 28, capacitor electrode 338 may overlap coil 42 whereas electrode 330 does not overlap coil 42, or electrode 330 may overlap coil 42 whereas electrode 338 does not overlap coil 42. Capacitor electrodes 330 and 338 of FIG. 16 may be formed elsewhere on device 28 and/or device 12 if desired.

The foregoing describes a technology that enables robust data transmission in the context of wireless power transfer. The present disclosure contemplates that it may be desirable for a power transmitter and a power receiver device to communicate information such as states of charge, charging speeds, so forth, to control wireless power transfer between devices.

It is possible, however, to transfer other kinds of data, such as data that are more personal in nature. Entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

To the extent that the present technology is leveraged to transmit personal information data, hardware and/or software elements can be provided for users to selectively block the use of, or access to, personal information data. For example, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

It is the intent of the present disclosure to describe a robust system for data transmission in a wireless power system. In implementations of this technology were personal information data is transmitted, that personal information data should be managed and handled in a way to minimize risks of unintentional or unauthorized access or use. Risk can be minimized by limiting the collection of data and deleting data once it is no longer needed. In addition, and when applicable, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

The foregoing is merely illustrative and various modifications can be made to the described embodiments. The foregoing embodiments may be implemented individually or in any combination.

What is claimed is:

1. A wireless power receiving device configured to wirelessly receive power during wireless power transmission from a wireless power transmitting device, the wireless power receiving device comprising:
wireless power receiving circuitry including a coil and rectifier, wherein the wireless power receiving circuitry is configured to receive wireless power signals with the coil and to supply a corresponding rectifier output voltage with the rectifier;
battery charger circuitry coupled to the wireless power receiving circuitry, wherein the battery charger circuitry is configured to generate a charging voltage based on the rectifier output voltage; and
a battery coupled to the battery charger circuitry, wherein the battery charger circuitry is configured to charge the battery using the charging voltage and wherein the battery charger circuitry comprises:
a switched capacitor converter that is configured to generate a converter output voltage by dividing the rectifier output voltage.

2. The wireless power receiving device defined in claim 1, wherein the battery charger circuitry is configured to use the converter output voltage as the charging voltage.

3. The wireless power receiving device defined in claim 2, wherein the battery charger circuitry further comprises a bypass switch coupled to an input of the switched capacitor converter, the bypass switch has first and second states, the battery charger circuitry is configured to use the converter output voltage as the charging voltage while the bypass switch is in the first state, and the battery charger circuitry is configured to use the rectifier output voltage as the charging voltage while the bypass switch is in the second state.

4. The wireless power receiving device defined in claim 1, wherein the battery charger circuitry further comprises an additional switched capacitor converter that is coupled between the switched capacitor converter and the battery and that is configured to generate an additional converter output voltage by dividing the converter output voltage.

5. The wireless power receiving device defined in claim 4, wherein the battery charger circuitry is configured to use the additional converter output voltage as the charging voltage.

6. The wireless power receiver device defined in claim 5, wherein the battery charger circuitry further comprises a buck converter coupled in parallel with the additional switched capacitor converter between the switched capacitor converter and the battery.

7. The wireless power receiver device defined in claim 6, wherein the battery charger circuitry further comprises a switch coupled between the switched capacitor converter, the additional switched capacitor converter, and the buck converter, the switch being configured to selectively activate a given one of the buck converter and the additional switched capacitor converter.

8. The wireless power receiver device defined in claim 5, wherein the battery charger circuitry further comprises a bypass switch coupled between the switched capacitor converter and the additional switched capacitor converter, the bypass switch has first and second states, the battery charger circuitry is configured to use the converter output voltage as the charging voltage while the bypass switch is in the first state, and the battery charger circuitry is configured to use the additional converter output voltage as the charging voltage while the bypass switch is in the second state.

9. The wireless power receiver device defined in claim 5, wherein the switched capacitor converter comprises a first set of switches that are activated during a first portion of a duty cycle and a second set of switches that are activated during a second portion of the duty cycle.

10. The wireless power receiver device defined in claim 1, wherein the battery charging circuitry further comprises a buck converter coupled in parallel with the switched capacitor converter between the rectifier and the battery.

11. The wireless power receiver device defined in claim 1, wherein the battery charging circuitry further comprises a buck converter coupled in series with the switched capacitor converter between the rectifier and the battery.

12. The wireless power receiver device defined in claim 11, further comprising a bypass switch coupled between the switched capacitor converter and the buck converter, the bypass switch being configured to selectively deactivate the buck converter.

13. The wireless power receiving device defined in claim 1, further comprising:
control circuitry coupled to the wireless power receiving circuitry, the battery charger circuitry, and the battery;
wireless transceiver circuitry coupled to the control circuitry; and
a capacitor electrode coupled to the wireless transceiver circuitry, wherein the control circuitry is configured to gather measurements associated with charging the battery and is configured to generate feedback signals based on the gathered measurements, the wireless transceiver circuitry being configured to capacitively transmit the feedback signals to the wireless power transmitting device using the capacitor electrode.

14. The wireless power receiving device defined in claim 13, further comprising:
an additional capacitor electrode coupled to the wireless transceiver circuitry, wherein the wireless transceiver circuitry is configured to receive capacitive signals from the wireless power transmitting device over the additional capacitor electrode.

15. The wireless power receiving device defined in claim 13, further comprising:
a ring-shaped capacitor electrode that is coupled to the wireless transceiver circuitry and that laterally surrounds the capacitor electrode.

16. The wireless power receiving device defined in claim 13, wherein the wireless transceiver circuitry is configured to de-modulate frequency-shift keying signals received from the wireless power transmitting device over the coil.

17. A wireless power receiving device configured to receive wireless power transmitted by a wireless power transmitting device at a duty cycle, the wireless power receiving device comprising:
wireless power receiving circuitry including a coil and a rectifier, wherein the rectifier is configured to receive wireless power signals with the coil and is configured to supply a corresponding output voltage;
battery charger circuitry coupled to the wireless power receiving circuitry and configured to convert the output voltage into a charging voltage;
a battery, wherein the battery charger circuitry is configured to charge the battery using the charging voltage;
control circuitry coupled to the battery charger circuitry and the battery, wherein the control circuitry is configured to generate feedback signals based on a signal measurement associated with the battery;
a wireless transmitter coupled to the control circuitry and configured to modulate the feedback signals generated by the control circuitry; and
a capacitor electrode, wherein the wireless transmitter is configured to adjust the duty cycle of the wireless transmitting device by wirelessly transmitting the modulated feedback signals using the capacitor electrode.

18. The wireless power receiving device defined in claim 17, wherein the battery charger circuitry comprises a switched capacitor converter configured to generate the charging voltage based on the output voltage.

19. The wireless power receiving device defined in claim 17, wherein the signal measurement comprises a signal measurement selected from the group consisting of: the output voltage, the charging voltage, a voltage within the battery charger circuitry, a current within the battery charging circuitry, and a current through the battery.

20. The wireless power receiving device defined in claim 17, wherein the capacitor electrode at least partially overlaps the coil.

21. A wireless power transmitting device configured to transmit wireless power signals to a wireless power receiving device, the wireless power transmitting device comprising:
a wireless power transmitting coil;
an inverter configured to drive the wireless power transmitting coil at a selected duty cycle;
control circuitry coupled to the inverter;
a wireless receiver coupled to the control circuitry; and
a capacitor electrode coupled to the wireless receiver, wherein the wireless receiver is configured to receive a wireless signal from the wireless power transmitting device using the capacitor electrode, and wherein the control circuitry is configured to control the inverter to adjust the selected duty cycle based on the wireless signal received using the capacitor electrode.
